(19) United States
(12) Patent Application Publication
(10) Pub. No.: US 2011/0216363 A1
(43) Pub. Date: Sep. 8, 2011

(54) REMOTE CONTROLLER, PRINTING SYSTEM AND PRINTING METHOD

(75) Inventor: Naoyuki Hattori, Shizuoka (JP)

(73) Assignee: TOSHIBA TEC KABUSHIKI KAISHA, Tokyo (JP)

(21) Appl. No.: 13/040,503

(22) Filed: Mar. 4, 2011

(30) Foreign Application Priority Data
Mar. 4, 2010 (JP) 2010-48319

(51) Int. Cl. G06F 3/12

(52) U.S. Cl. 358/1.15

(57) ABSTRACT

A remote controller including a connector to which a storing medium storing printing data to be printed is connected. The remote controller may further include a read unit which reads the printing data from the storing medium connected to the connector. The remote controller may further include a transmission unit which transmits the printing data read by the read unit to a printing apparatus.

### CROSS-REFERENCE TO RELATED APPLICATIONS

This application is based upon and claims the benefit of priority from Japanese Patent Application No. 2010-48319, filed on Mar. 4, 2010, the entire contents of which is incorporated herein by reference.

### FIELD

Embodiments described herein relate generally to a remote controller, a printing system and a printing method.

### BACKGROUND

In order to control the input of setting information and operations for a label printer, a user uses buttons provided on a main body of the label printer while viewing a liquid crystal display provided on the main body of the label printer. In recent years, to meet the demand for overcoming limitations in the structural arrangement of label printers and facilitating the customization of an operation screen, there has been proposed a label printer in which a main body of the label printer is separated from an operation panel and is connected to the operation panel via a wireless interface.

However, a connector such as a universal serial bus (USB) to which a storage medium such as a USB memory is connected, is usually arranged at a rear portion of the printer, while a power button or a tray is arranged at a front portion of the label printer. Therefore, if the rear portion of the label printer is only a small distance away from a wall, it may be difficult to insert a storage medium to a connector located on a rear portion of the label printer.

### BRIEF DESCRIPTION OF THE DRAWINGS

FIG. 1 is a block diagram showing a configuration of a printing system according to one embodiment.

FIG. 2 is a front view showing a remote controller according to one embodiment.

FIG. 3 is a side view showing the remote controller.

FIG. 4 is a block diagram showing an electrical configuration of the printer and the remote controller.

FIG. 5 is a block diagram showing a functional configuration of the printer and the remote controller.

FIG. 6 is a flow chart showing a process of transmitting a printing image by the remote controller according to one embodiment.

FIG. 7 is a flow chart showing a process of printing a printing image according to one embodiment.

### DETAILED DESCRIPTION

According to one embodiment, a remote controller includes a connector to which a storing medium storing printing data to be printed is connected. The remote controller may further include a read unit which reads the printing data from the storing medium connected to the connector. The remote controller may further include a transmission unit which transmits the printing data read by the read unit to a printing apparatus.

Exemplary embodiments of a remote controller, a printing system and a printing method will now be described in detail with reference to the drawings.

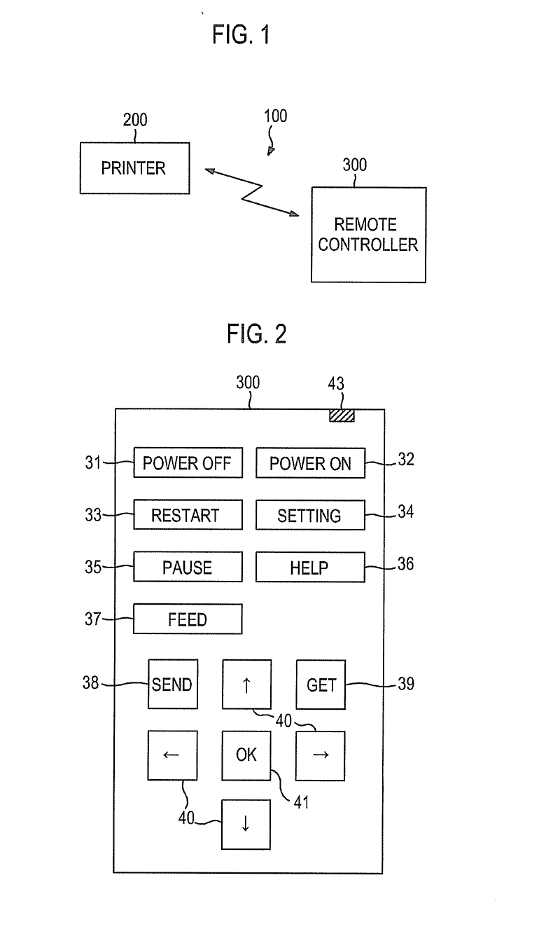

FIG. 1 is a block diagram showing a configuration of a printing system according to one exemplary embodiment. In this embodiment, a printing system 100 includes a remote controller (hereinafter “RC”) 300 and a printer 200 operated by the RC 300. In this embodiment, it is assumed that the printer 200 and the RC 300 conduct wireless communication with each other via infrared communication or Bluetooth®. Although it is illustrated in this embodiment that the printer 200 conducts wireless communication with the RC 300, the communication may be conducted through wired communication.

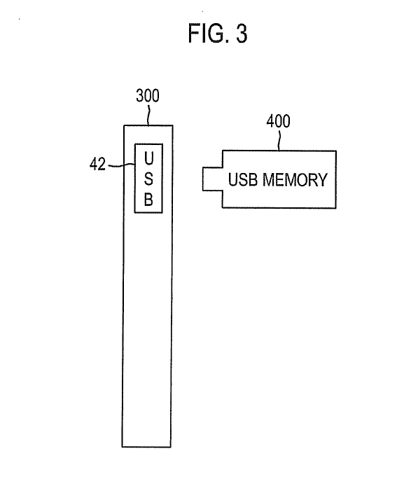

FIGS. 2 and 3 show a front view and a side view of the RC 300, respectively. In this embodiment, the RC 300 includes a POWER OFF button 31, a POWER ON button 32, a RESTART button 33, a SETTING button 34, a PAUSE button 35, a HELP button 36, a FEED button 37, a SEND button 38, a GET button 39, four arrow (or four directions) buttons 40, an OK button 41, etc.

In this embodiment, the RC 300 further includes a universal serial bus (USB) connector 42. The USB connector 42 is a connector to which a USB memory 400, which is a storage medium to store printing data to be printed, is connected. Although in this embodiment, the connector is implemented by employing the USB connector 42 connected to the USB memory 400, this embodiment is not limited the use of a USB connector or USB memory. For example, a PC card slot which may be connected with a PC card may be used as the connector. Alternatively, any other types of external memory ports may be used as the connector.

In this embodiment, the RC 300 further includes a light emitting diode (LED) 43 which indicates various states of the RC 300.

The POWER OFF button 31 is a power button which instructs the printer 200 to be powered off to switch the printer 200 to a standby mode. The POWER ON button 32 is a power button which instructs the printer 200 to be powered on to switch back the printer 200 from the standby mode to a normal operation mode.

The RESTART button 33, the PAUSE button 35 and the FEED button 37 are buttons which control basic operations of the printer 200 while the printer 200 is being powered on, instructing the printer 200 to resume a printing operation, suspend the printing operation, and feed forward a printing medium, respectively.

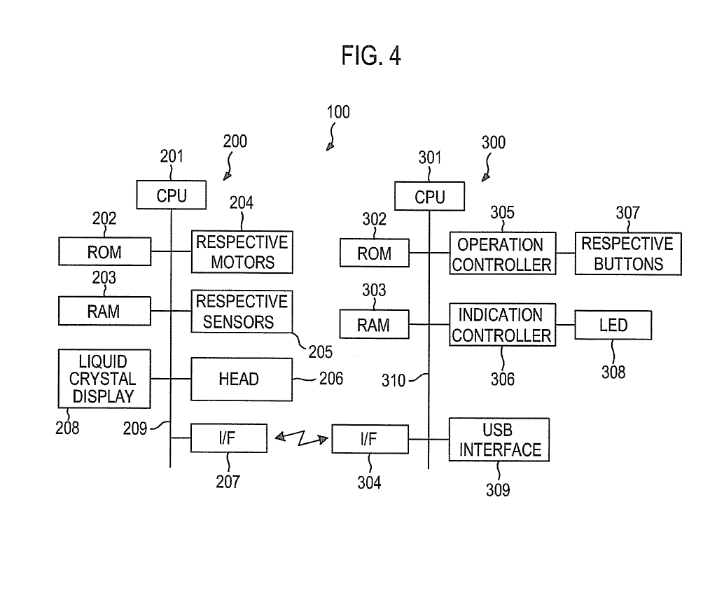

The SETTING button 34 is a button which instructs a liquid crystal display 208 (see FIG. 4) of the main body of the printer 200 to display a menu screen which allows a user to make various settings such as altering paper size. The four arrow buttons 40 are buttons which allow a user to select various settings from the menu screen displayed on the liquid crystal display 208 (see FIG. 4). The OK button 41 is a button which allows a user to confirm a selection of various settings by the four arrow buttons 40.

The HELP button 36 is a button which instructs the liquid crystal display 208 (see FIG. 4) to display a procedure of resolving an error, which may occur in the body of the printer 200.

The GET button 39 is a button which instructs the RC to read printing data from the USB memory 400 connected to the USB connector 42. The SEND button 38 is a transmission instruction button which instructs transmission of the printing data read from the USB memory 400 (or a printing image that is generated by rendering the printing date) to the printer 200. In the following description, the POWER OFF button 31, the POWER ON button 32, the RESTART button 33, the SETTING button 34, the PAUSE button 35, the HELP button 36, the FEED button 37, the SEND button 38, the GET button 39, the four arrow buttons 40 and the OK button 41 are collectively referred to as “respective buttons 307” (see FIG. 4).

FIG. 4 is a block diagram showing an electrical configuration of the printer and the RC according to this embodiment. The printer 200 includes a central processing unit (CPU) 201 which is a main component of the printer 200 for performing centralized control of the other components. In addition, the printer 200 includes a read only memory (ROM) 202 which stores a control program of the printer 200 and so on, and a random access memory (RAM) 203 which is a rewritable memory to store various data, both of which are connected to the CPU 201 via a bus 209. In addition, the printer 200 includes respective motors 204 such as a conveying motor, respective sensors 205 which may detect a position of a paper being conveyed in the printer 200, a head 206 which generates heat and performs printing on a printing side of the paper, an interface (I/F) 207 which performs wireless communications between the printer 200 and the RC 300, and the liquid crystal display 208 which displays various information, all of which are connected to the CPU 201 via the bus 209.

The RC 300 includes a CPU 301 which is a main component of the RC 300 for performing centralized control of the other components. In addition, the RC 300 includes a ROM 302 which stores a control program of the RC 300 and so on, and a RAM 303 which is a rewritable memory to store various data, both of which are connected to the CPU 301 via a bus 310. In addition, the RC 300 includes an operation panel controller 305 which controls operation of respective buttons 307, an indication controller 306 which controls a LED 308 which indicates various states of the RC 300, an I/F 304 which performs wireless communications between the printer 200 and the RC 300, and a USB interface 309 which controls communication in transmitting/receiving data to/from the USB Memory 400 through the USB connector 42, all of which are connected to the CPU 301 via the bus 310.

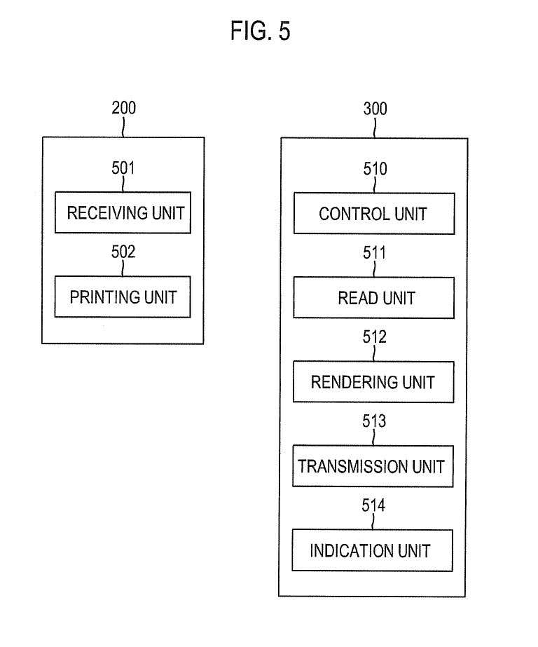

Exemplary functions of the printer 200 and the RC 300 according to one embodiment, which are performed by control programs which are stored in the ROMs 202 and 302 and are executed by the CPUs 201 and 301, will be described. FIG. 5 is a block diagram showing a functional configuration of the printer 200 and the RC 300.

In this embodiment, the RC 300 includes a control unit 510, a read unit 511, a rendering unit 512, a transmission unit 513 and an indication unit 514 that may be implemented by executing the control program.

The control unit 510 switches an operation mode of the printer 200 to a standby mode (i.e., powers off the printer 200) if the printer 200 is instructed to be powered off by the POWER OFF button 31. In addition, the control unit 510 switches the operation mode of the printer 200 back from the standby mode to a normal operation mode (i.e., powers on the printer 200) if the printer 200 is instructed to be powered on by the POWER ON button 32.

In addition, the control unit 510 may switch back the operation mode of the printer 200 from the standby mode to the normal operation mode (i.e., powers on the printer 200) if instructed by the GET button 39 to read the printing data stored in the USB memory 400. In this case, the printer 200 may be regarded as being instructed to be powered on by the POWER ON button 32. If the printer 200 has been already powered on before the GET button 39 instructs the printing data to be read, the control unit 510 does not perform the above-mentioned operation mode switching action.

The read unit 511 reads the printing data from the USB memory 400 connected to the USB connector 42 if instructed by the GET button 39 to read the printing data stored in the USB memory 400.

The rendering unit 512 renders printing images in the RAM 303 based on the printing data read by the read unit 511. The printing image is formatted data for output by a printer.

If instructed by the SEND button 38 to transmit the printing image rendered in the RAM 303, the transmission unit 513 transmits the printing images rendered in the RAM 303 by the rendering unit 512 to the printer 200 through the I/F 304 when the printer 200 has already been instructed to be powered on by the POWER ON button 32 (or the GET button 39), and switched back from the standby mode to the normal operation mode (i.e., when the printer 200 is powered on).

In this embodiment, the transmission unit 513 transmits the printing images rendered in the RAM 303 by the rendering unit 512 to the printer 200. Alternatively, if the printer 200 includes a rendering unit to render a printing image from printing data, the transmission unit 513 may transmit the printing data read by the read unit 511 from the USB memory 400 to the printer 200.

The indication unit 514 changes lighting patterns such as color or a lighting-on/off pattern of the LEDs 308 that may be determined according to a read state where the printing data are read by the read unit 511, a rendering state where the printing images are rendered by the rendering unit 512, and a transmission state where the printing images are transmitted by the transmission unit 513.

For example, the indication unit 514 may light one of the LEDs 308 which is green when in the read state, one of the LEDs 308 which is red when in the rendering state, and turn off the LEDs 308 when in the transmission state. In addition, depending on whether or not end data is transmitted from the printing images rendered in the RAM 303, the indication unit 514 determines whether or not transmission of the printing images to the printer 200 has been completed.

In addition, although in this embodiment the indication unit 514 changes the lightning pattern of the LEDs 308, the present disclosure is not limited thereto as long as the respective states can be identified. For example, the indication unit 514 may generate different sounds to indicate the respective states. Further, the indication unit 514 may indicate the respective states by vibrating the RC 300. For example, the indication unit 514 indicates the respective states by setting different numbers of vibration of the RC 300 for the respective states. In this manner, even for a RC 300 having no display function, it is possible to easily and distinctly inform an operator of the respective states, such as the transmission state where the printing images are transmitted, by indicating the respective states of the RC 300 using sound or vibration.

Further, in this embodiment, the printer 200 includes a receiving unit 501 and a printing unit 502 that may be implemented by executing a control program.

The receiving unit 501 receives the printing images transmitted by the transmission unit 513 of the RC 300 through the I/F 207.

Although the printing images are received from the transmission unit 513 of the RC 300 in this embodiment, the printing data (from which the printing images are rendered) may be received from the transmission unit 513 according to another embodiment. If the printing data are received by the receiving unit 501, the CPU 201 renders the printing images in the RAM 203 based on the received printing data.

The printing unit controls the head 206 to print the printing images received by the receiving unit 501 (or the printing images rendered in the RAM 203).

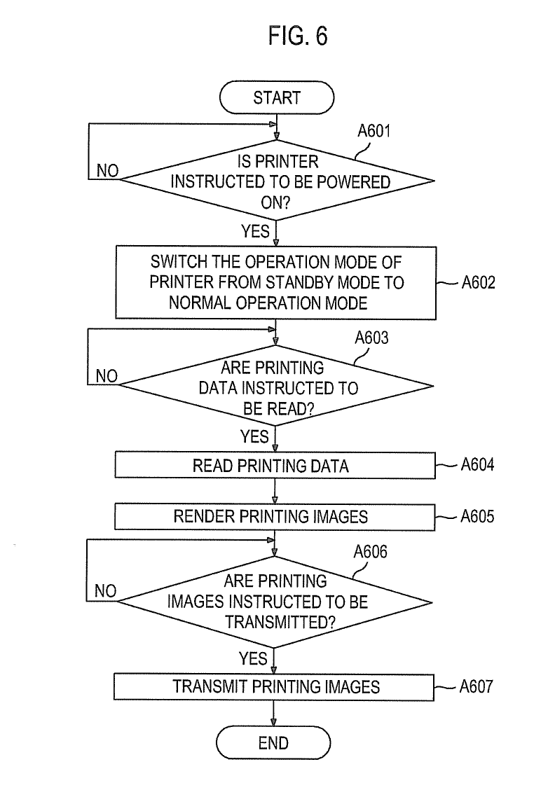

FIG. 6 is a flow chart showing a process of transmitting the printing images by the RC 300 according to one embodiment.

The control unit 510 determines whether or not the printer 200 is instructed to be powered on by the POWER ON button 32 (Act A601). If the printer 200 is instructed to be powered on (YES in Act A601), the control unit 510 switches back the operation mode of the printer 200 from a standby mode to the normal operation mode (Act A602).

Subsequently, when the operation mode of the printer 200 is switched back from the standby mode to normal operation mode, the read unit 511 determines whether or not the GET button 39 instructs reading of printing data (Act A603). If the GET button 39 instructs reading of printing data (YES in Act A603), the read unit 511 reads the printing data from the USB memory 400 connected to the USB connector 42 (Act A604).

Once the printing data are read by the read unit 511, the rendering unit 512 renders printing images based on the printing data read by the read unit 511 in the RAM 303 (Act A605).

Once the printing images are rendered in the RAM 303, the transmission unit 513 determines whether or not the SEND button 38 instructs transmission of the printing images (Act A606). If the SEND button 38 instructs the printing images to be transmitted (YES in act A606), the transmission unit 513 transmits the printing images rendered in the RAM 303 to the printer 200 (Act A607).

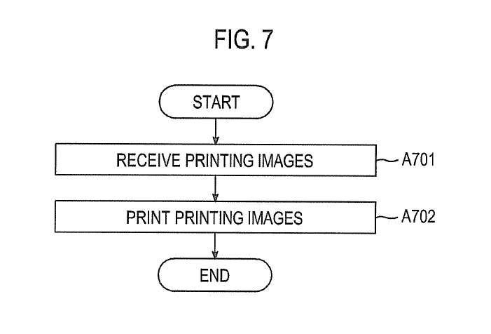

FIG. 7 is a flow chart showing a process of printing the printing images.

The receiving unit 501 waits for reception of the printing images from the RC 300 if the operation mode of the printer 200 is switched back from the standby mode to the normal operation mode. If the printing images transmitted from the RC 300 are received by the receiving unit 501 (Act A701), the printing unit 502 controls the head 206 to print the received printing images (Act A702).

Although in this embodiment, the control programs to be executed by the printer 200 and the RC 300 are previously prepared and stored in the ROMs 202 and 302, the present invention is not limited thereto.

For example, the control programs executed by the printer 200 and the RC 300 according to this embodiment may be stored in a computer-readable recording medium such as a CD-ROM, a flexible disk (FD), a CD-R, a digital versatile disk (DVD) or the like in an installable or executable form.

Further, the control programs executed by the printer 200 and the RC 300 according to this embodiment may be stored in a computer connected to a network such as an internet and may be downloaded to the printer 200 and the RC 300 via the network. Moreover, the control programs executed by the printer 200 and the RC 300 according to this embodiment may be provided or distributed over a network such as an internet.

In the printing system 100 according to the embodiment as described above, the RC 300 includes the USB connector 42 to which the USB memory 400 storing the print data to be printed is connected, the read unit 511 which reads the printing data from the USB memory 400 connected to the USB connector 42, the rendering unit 512 which renders the printing data read by the read unit 511 into the printing images, and the transmission unit 513 which transmits the printing images from the rendering unit 512 to the printer 200 when the POWER ON button 32 instructs the printer 200 to be powered on. Further, the printer 200 of the printing system 100 includes the receiving unit 501 which receives the printing images transmitted from the transmission unit 513 of the RC 300, and the printing unit 502 which prints the printing images received by the receiving unit 501. Thus, when the printing data stored in the USB memory 400 are to be printed, there is no need to connect the USB memory to the USB connector arranged at a rear portion of the printer 200, which improves the convenience of the printer 200.

In addition, in the printing system 100 according to this embodiment, since the printing images (or the printing data) are transmitted to the printer 200 when the printer 200 is powered on by the instructions from the POWER ON button 32 of the RC 300, the printing data may be reliably transferred from the RC 300 to the printer 200.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A remote controller comprising:
a connector connectable to a storing medium storing printing data to be printed;
a read unit configured to read the printing data from the storing medium through the connector; and
a transmission unit configured to transmit the printing data read by the read unit to a printing apparatus.

2. The remote controller of claim 1, further comprising a power button which instructs the printing apparatus to be powered on,
wherein the transmission unit transmits the printing data to the printing apparatus when the printing apparatus is powered on.

3. The remote controller of claim 1, wherein the connector is a USB connector to which a USB memory as the storing medium is connected.

4. The remote controller of claim 1, wherein the connector is a PC card slot to which a PC card as the storing medium is connected.

5. The remote controller of claim 1, wherein the connector is an external memory port to which the storing medium is connected.

6. The remote controller of claim 1, further comprising an indication unit configured to selectively indicate a read state when the printing data is being read by the read unit, and a transmission state when the printing data is being transmitted by the transmission unit.

7. The remote controller of claim 1, further comprising a rendering unit configured to render printing images based on the printing data,
wherein the printing data transmitted by the transmission unit are the printing images rendered by the rendering unit.

8. The remote controller of claim 7, further comprising a power button which instructs the printing apparatus to be powered on,
wherein the transmission unit transmits the printing images to the printing apparatus when the printing apparatus is powered on.

9. The remote controller of claim 7, further comprising an indication unit configured to selectively indicate a read state when the printing data is being read by the read unit, a rendering state when the printing images are being rendered from the printing data, and a transmission state when the printing images are being transmitted by the transmission unit.

10. A printing system comprising:
a remote controller; and
a printing apparatus configured to be operated by the remoter controller,
the remote controller including:
a connector connectable to a storing medium storing printing data to be printed;
a read unit configured to read the printing data from the storing medium through the connector; and
a transmission unit configured to transmit the printing data read from the storing medium to the printing apparatus, and
the printing apparatus including:
a receiving unit configured to receive the printing data transmitted by the transmission unit
an rendering unit configured to render printing images based on the printing data; and
a printing unit configured to print the printing images.

11. The printing system of claim 10, wherein the remote controller further includes a power button which instructs the printing apparatus to be powered on,
wherein the transmission unit transmits the printing data to the printing apparatus when the printing apparatus is powered on.

12. The printing system of claim 10, wherein the connector is a USB connector to which a USB memory as the storing medium is connected.

13. The printing system of claim 10, wherein the connector is a PC card slot to which a PC card as the storing medium is connected.

14. The printing system of claim 10, wherein the connector is an external memory port to which the storing medium is connected.

15. The printing system of claim 10, wherein the remote controller further comprises an indication unit configured to selectively indicate a read state when the printing data is being read by the read unit and a transmission state when the printing data is being transmitted by the transmission unit.

16. A printing method in a remote controller including a connector to which a storing medium storing printing data is connected, the method comprising:
reading the printing data from the storing medium by a read unit of the remote controller; and
transmitting the printing data from the remote controller to a printing apparatus by a transmission unit.

17. The method of claim 16, further comprising selectively indicating a read state when the printing data is being read by the read unit, and a transmission state when the printing data is being transmitted by the transmission unit.

18. The method of claim 16, further comprising:
rendering printing images of the printing data by a rendering unit,
wherein the printing data transmitted by the transmission unit are the printing images rendered by the rendering unit.

19. The method of claim 18, further comprising selectively indicating a read state when the printing data is being read by the read unit, a rendering state when the printing images are being rendered from the printing data, and a transmission state when the printing images are being transmitted.

20. The method of claim 16, wherein the connector is a USB connector or a PC card slot.
